(19) United States
(12) Patent Application Publication
(10) Pub. No.: US 2026/0128629 A1
(43) Pub. Date: May 7, 2026

(54) MINIATURE INTEGRATED HIGH-REDUCTION-RATIO POWER DEVICE INTEGRATED WITHIN MINIATURE OUTER ROTOR

(71) Applicant: Fuyao University of Science and Technology, Fuzhou City (CN)

(72) Inventors: Hongxing WU, Fuzhou City (CN); Weiming SHEN, Fuzhou City (CN); Hui YOU, Fuzhou City (CN); Peng GAO, Fuzhou City (CN); Jiaxin FAN, Fuzhou City (CN); Xianping LIU, Fuzhou City (CN); Yue WU, Fuzhou City (CN); Wei SHEN, Fuzhou City (CN)

(73) Assignee: Fuyao University of Science and Technology, Fuzhou City (CN)

(21) Appl. No.: 19/351,941

(22) Filed: Oct. 7, 2025

(30) Foreign Application Priority Data
Nov. 6, 2024 (CN) 202411573301.3

(51) Int. Cl. H02K 1/2786; H02K 7/00; H02K 7/08; H02K 7/116

(52) U.S. Cl. CPC H02K 1/2786; H02K 7/003; H02K 7/085; H02K 7/088; H02K 7/116

(57) ABSTRACT

A miniature high-reduction-ratio power device integrated within an outer rotor is provided, which includes a motor rotor, a rotor permanent magnet, a stator winding, a stator core, an internal fixing casing and an end cover. A primary sun gear is connected with a rotor output shaft of the motor rotor. Multiple primary planetary gears are meshed outside the primary sun gear, and a primary planetary gear carrier is connected with the primary planetary gears. A secondary sun gear is connected with the primary planetary gear carrier. Multiple secondary planetary gears are meshed outside the secondary sun gear, and the secondary planetary carrier is connected with the secondary planetary gears. A tertiary sun gear is connected with the secondary planetary carrier. Multiple tertiary planetary gears are meshed outside the tertiary sun gear, and a tertiary planetary carrier is connected with the multiple tertiary planetary gears.

### CROSS-REFERENCE TO RELATED APPLICATION

This patent application claims the benefit and priority of Chinese Patent Application No. 202411573301.3, entitled “MINIATURE INTEGRATED HIGH-REDUCTION-RATIO POWER DEVICE INTEGRATED WITHIN MINIATURE OUTER ROTOR” filed on Nov. 6, 2024, the disclosure of which is incorporated by reference herein in its entirety as part of the present application.

### TECHNICAL FIELD

The present disclosure relates to the technical field of mechanical engineering automation, and in particular to a miniature high-reduction-ratio power device integrated within an outer rotor.

### BACKGROUND

The device including a motor and a reducer has a very wide application range, for example, these devices are all popular in the fields such as industrial automatic production lines, robotics, automotive transmission systems, and household appliances. By using the reducer, the speed and the output torque of the motor can be effectively adjusted to allow the machine to operate under a wider range of conditions and improve efficiency and performance. Such devices may be divided into two main portions: the motor and the reducer.

The conventional device including a motor and reducer is typically a structure in which the motor and the reducer are connected in series, the reducer is mounted on an outer side of the motor, and this traditional structure is an elongated structure and is not conducive to high-integration scenarios, and especially in a scenario where a robot joint and a volume are restrained. Therefore, the present disclosure provides a miniature high-reduction-ratio power device integrated within an outer rotor to solve such a problem.

### SUMMARY

The embodiments aim to provide a miniature high-reduction-ratio power device integrated within an outer rotor, in order to solve a problem that the conventional device including the motor and the reducer is typically a structure in which the motor and the reducer are connected in series, and the reducer is mounted on an outer side of the motor, which is not conducive to high-integration scenarios.

To achieve the above objective, the present disclosure provides the following technical solutions.

A basic technical solution of the present disclosure is as follows. A miniature high-reduction-ratio power device integrated within an outer rotor includes a motor rotor, a rotor permanent magnet, a stator winding, a stator core, an internal fixing casing, an end cover and a straight end cover opening. The internal fixing casing is fixedly connected with the end cover. The motor rotor is rotatably connected with the internal fixing casing. The motor rotor is provided with a rotor output shaft. a primary sun gear is fixedly connected with the rotor output shaft through a first D-shaped shaft hole. Multiple primary planetary gears are meshed outside the primary sun gear in an encircling manner. A primary planetary gear carrier is rotatably connected with the multiple primary planetary gears. A secondary sun gear is fixedly connected with an output shaft of the primary planetary gear carrier through a second D-shaped shaft hole. Multiple secondary planetary gears are meshed outside the secondary sun gear in an encircling manner. A secondary planetary gear carrier is rotatably connected with the multiple secondary planetary gears. a tertiary sun gear is fixedly connected with an output shaft of the secondary planetary gear carrier through a third D-shaped shaft hole. Multiple tertiary planetary gears are meshed outside the tertiary sun gear in an encircling manner. A tertiary planetary carrier is rotatably connected with the multiple tertiary planetary gears. The tertiary planetary carrier is provided with a planetary reducer output shaft.

The principle of the basic technical solution is as follows. A rotor shaft permanent magnet drives the motor rotor to rotate, the rotor output shaft drives the primary sun gear to rotate, the primary sun gear drives the primary planetary gears to revolve while the primary planetary gear performs a circumferential movement about the axis of the primary sun gear, and thus the primary planetary gear carrier drives the secondary sun gear to rotate, so as to achieve the purpose of primary speed reduction. The secondary sun gear drives the secondary planetary gears to revolve while the secondary planetary gear performs a circumferential movement about the axis of the secondary sun gear, and thus the secondary planetary gear carrier drives the tertiary sun gear to rotate, so as to achieve the purpose of secondary speed reduction. The tertiary sun gear drives the tertiary planetary gears to revolve while the tertiary planetary gear performs a circumferential movement about the axis of the tertiary sun gear, and thus the tertiary planetary carrier drives the planetary reducer output shaft to rotate, so as to achieve the purpose of tertiary speed reduction.

The basic technical solution has the following beneficial effects. By means of the cooperation of the sun gears and the planetary gears, the power device has a large reduction gear ratio and stable performance and is convenient to utilize. A main body of the power device includes an outer rotor motor and a tertiary planetary reducer, and the tertiary planetary reducer is disposed at an internal hollow portion of a motor stator, such that the internal hollow portion of the motor stator is reasonably utilized, a combined length and a combined volume of the motor and the reducer are thus decreased, and the purpose of high integration is achieved.

In some embodiments, the motor rotor is provided with a bearing chamber, the bearing chamber is provided with a first bearing, and the motor rotor is rotatably connected with the internal fixing casing by means of the first bearing.

With the above configuration, by providing the first bearing, the motor rotor can rotate more smoothly, and the wear of the motor rotor and the internal fixing casing is reduced.

In some embodiments, second bearings are disposed respectively between the multiple primary planetary gears and the primary planetary gear carrier, between the multiple secondary planetary gears and the secondary planetary gear carrier and between the multiple tertiary planetary gears and the tertiary planetary gear carrier.

With the above configuration, by providing the second bearing, a rotational friction force between the planetary gear carrier and the corresponding planetary gear is decreased, and the reliability thereof is improved.

In some embodiments, a third bearing is disposed between the planetary reducer output shaft and the end cover.

With the above configuration, by providing the third bearing, the end cover has a certain supporting effect on the planetary reducer output shaft while the rotation accuracy thereof is not affected.

In some embodiments, an inner wall of the internal fixing casing is provided with inner ring teeth, and the multiple first planetary gears, the multiple second planetary gears and the multiple tertiary planetary gears are meshed with the inner ring teeth.

With the above configuration, by providing the inner ring teeth, the planetary gears are further limited, and thus the stability and reliability thereof are ensured.

### BRIEF DESCRIPTION OF THE DRAWINGS

FIG. 1 is a first structural schematic diagram of a miniature high-reduction-ratio power device integrated within an outer rotor according to the present disclosure;

FIG. 2 is a second structural schematic diagram of the miniature high-reduction-ratio power device integrated within the outer rotor according to the present disclosure;

FIG. 3 is a third structural schematic diagram of the miniature high-reduction-ratio power device integrated within the outer rotor according to the present disclosure;

FIG. 4 is a fourth structural schematic diagram of the miniature high-reduction-ratio power device integrated within the outer rotor according to the present disclosure;

FIG. 5 is a fifth structural schematic diagram of the miniature high-reduction-ratio power device integrated within the outer rotor according to the present disclosure;

1 motor rotor; 2 motor permanent magnet; 3 stator winding; 4 stator core; 5 internal fixing casing; 6 bearing chamber; 7 rotor output shaft; 8 first bearing; 9 straight end cover opening; 10 primary planetary gear; 11 secondary planetary gear; 12 primary sun gear; 13 primary planetary gear carrier; 14 second bearing; 15 secondary planetary gear carrier; 16 tertiary planetary gear carrier; 17 secondary sun gear; 18 tertiary sun gear; 19 tertiary planetary gear; 20 end cover; 21 planetary reducer output shaft; 22 third bearing; 23 inner ring teeth.

### DETAILED DESCRIPTION OF THE EMBODIMENTS

The present disclosure will be described further in detail below with reference to drawings and embodiments:

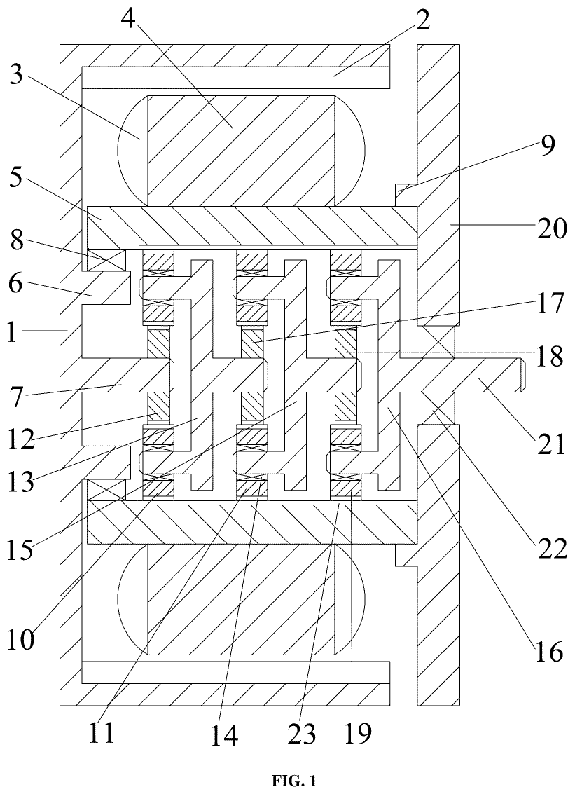

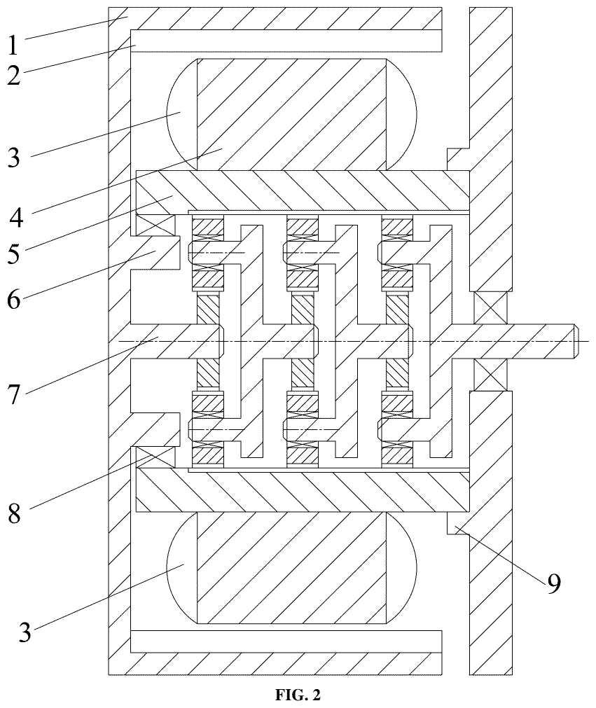

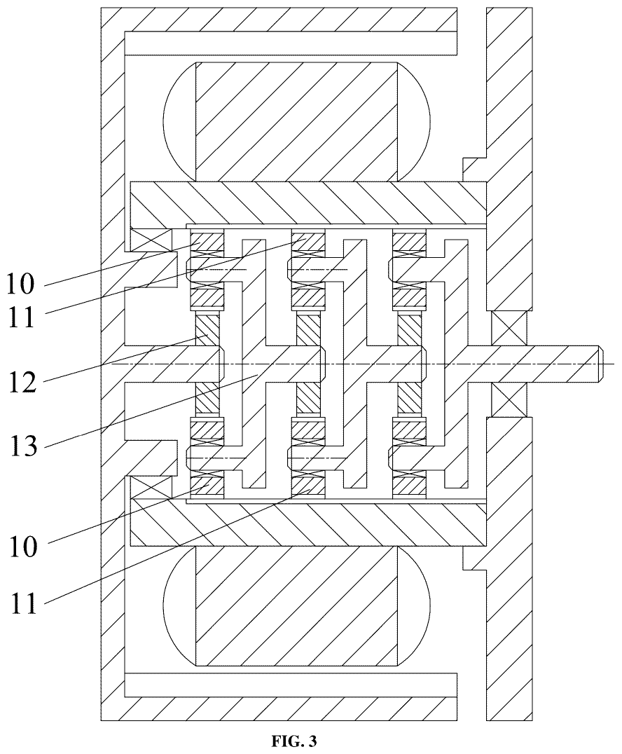

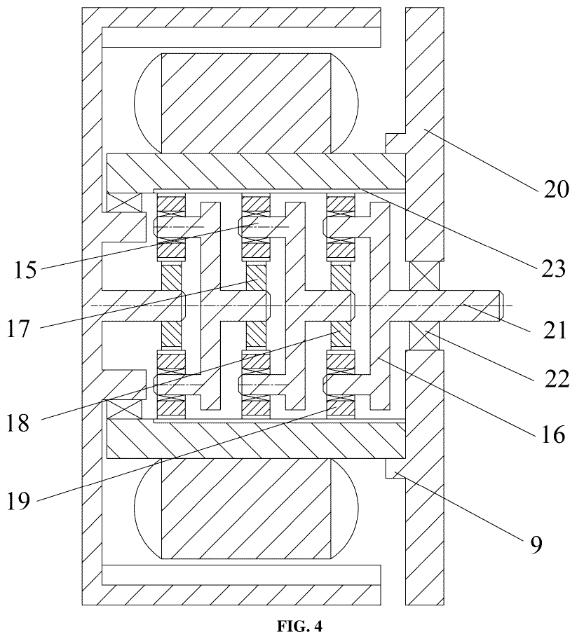

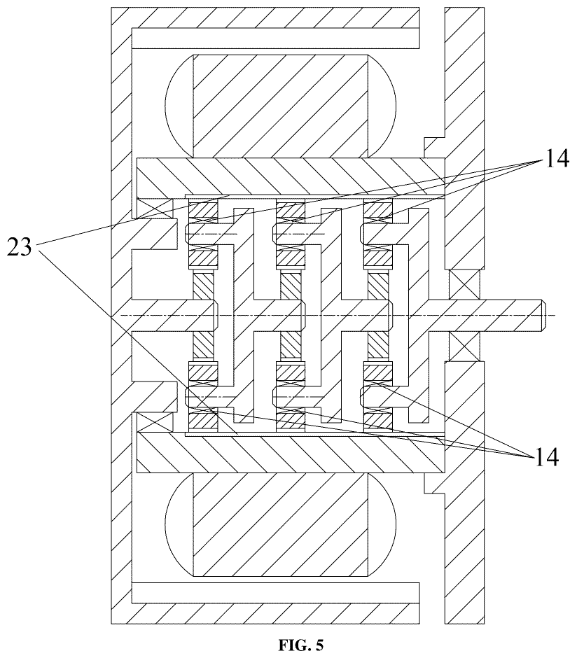

As shown in FIGS. 1 to 5, a miniature high-reduction-ratio power device integrated within an outer rotor includes a motor rotor 1, a rotor permanent magnet 2, a stator winding 3, a stator core 4, an internal fixing casing 5, an end cover 20 and a straight end cover opening 9. The internal fixing casing 5 is fixedly connected with the end cover 20. The motor rotor 1 is provided with a bearing chamber 6. The bearing chamber 6 is provided with a first bearing 8. The motor rotor 1 is rotatably connected with the internal fixing casing 5 by means of the first bearing 8. The motor rotor 1 is provided with a rotor output shaft 7. A primary sun gear 12 is fixedly connected with the rotor output shaft 7 through a D-shaped shaft hole. Multiple primary planetary gears 10 are meshed outside the primary sun gear 12 in an encircling manner. A primary planetary gear carrier 13 is rotatably connected with the primary planetary gears 10. A secondary sun gear 17 is fixedly connected with an output shaft of the primary planetary gear carrier 13 through a D-shaped shaft hole. Multiple secondary planetary gears 11 are meshed outside the secondary sun gear 17 in an encircling manner. A secondary planetary gear carrier 15 is rotatably connected with the secondary planetary gears 11. A tertiary sun gear 18 is fixedly connected with an output shaft of the secondary planetary gear carrier 15 through a D-shaped shaft hole. Multiple tertiary planetary gears 19 are meshed outside the tertiary sun gear 18 in an encircling manner. Second bearing 14 are disposed respectively between the primary planetary gears 10 and the primary planetary gear carrier 13, between the secondary planetary gears 11 and the secondary planetary gear carrier 15 and between the tertiary planetary gears 19 and the tertiary planetary gear carrier 16. An inner wall of the internal fixing casing 5 is provided with inner ring teeth 23. The primary planetary gears 10, the secondary planetary gears 11 and the tertiary planetary gears 19 are all meshed with the inner ring teeth 23. A tertiary planetary carrier 16 is rotatably connected with the tertiary planetary gears 19. The tertiary planetary carrier 16 is provided with a planetary reducer output shaft 21, and a third bearing 22 is disposed between the planetary reducer output shaft 21 and the end cover 20.

A specific implementation process is as follows.

When the present disclosure is utilized, the motor rotor 1 is provided with the permanent magnet for providing an alternating magnetic field NS to the motor. The stator core 4 of the motor has a tooth groove structure, and the stator winding 3 is wound around the tooth groove structure. When the stator winding 3 is energized, a rotating magnetic field is generated and interacts with the alternating magnetic field of the permanent magnet NS of the rotor to generate a torque, and the motor rotor 1 is thus controlled to rotate. The rotor output shaft 7 drives the primary sun gear 12 to rotate, the primary sun gear 12 drives the primary planetary gears 10 to revolve while the primary planetary gear performs a circumferential movement about the axis of the primary sun gear, and thus the primary planetary gear carrier 13 drives the secondary sun gear 17 to rotate, so as to achieve the purpose of primary speed reduction. The secondary sun gear 17 drives the secondary planetary gears 11 to revolve while the secondary planetary gear performs a circumferential movement about the axis of the secondary sun gear, and thus the secondary planetary gear carrier 15 drives the tertiary sun gear 18 to rotate, so as to achieve the purpose of secondary speed reduction. The tertiary sun gear 18 drives the tertiary planetary gears 19 to revolve while the tertiary planetary gear performs a circumferential movement about the axis of the tertiary sun gear 18, and thus the tertiary planetary carrier 16 drives the planetary reducer output shaft 21 to rotate, so as to achieve the purpose of tertiary speed reduction.

The above description illustrates merely the embodiments of the present disclosure, and general knowledge including specific technical solutions or features known in the solutions are not described too much herein. It should be noted that those skilled in the art can make several modifications and improvements without departing from the technical solutions of the present disclosure, and these modifications and improvements should also be construed as the scope of protection of the present disclosure, none of which would affect the implementation effect of the present disclosure or the practicability of the patent. The scope of protection claimed in the present disclosure shall be subject to the content of the claims, and the description of the specific embodiments and the other recited may be used to interpret the content of the claims.

What is claimed is:

1. A miniature high-reduction-ratio power device integrated within an outer rotor, comprising a motor rotor (1), a rotor permanent magnet (2), a stator winding (3), a stator core (4), an internal fixing casing (5), an end cover (20) and a straight end cover opening (9); wherein the internal fixing casing (5) is fixedly connected with the end cover (20), the motor rotor (1) is rotatably connected with the internal fixing casing (5), the motor rotor (1) is provided with a rotor output shaft (7), a primary sun gear (12) is fixedly connected with the rotor output shaft (7) through a first D-shaped shaft hole, a plurality of primary planetary gears (10) are meshed outside the primary sun gear (12) in an encircling manner, and a primary planetary gear carrier (13) is rotatably connected with the plurality of primary planetary gears (10), a secondary sun gear (17) is fixedly connected with an output shaft of the primary planetary gear carrier (13) through a second D-shaped shaft hole, a plurality of secondary planetary gears (11) are meshed outside the secondary sun gear (17) in an encircling manner, a secondary planetary gear carrier (15) is rotatably connected with the plurality of secondary planetary gears (11), a tertiary sun gear (18) is fixedly connected with an output shaft of the secondary planetary gear carrier (15) through a third D-shaped shaft hole, and a plurality of tertiary planetary gears (19) are meshed outside the tertiary sun gear (18) in an encircling manner, a tertiary planetary carrier (16) is rotatably connected with the plurality of tertiary planetary gears (19), and the tertiary planetary carrier (16) is provided with a planetary reducer output shaft (21).

2. The miniature high-reduction-ratio power device integrated within the outer rotor according to claim 1, wherein the motor rotor (1) is provided with a bearing chamber (6), the bearing chamber (6) is provided with a first bearing (8), and the motor rotor (1) is rotatably connected with the internal fixing casing (5) by means of the first bearing (8).

3. The miniature high-reduction-ratio power device integrated within the outer rotor according to claim 1, wherein second bearings (14) are disposed respectively between the plurality of primary planetary gears (10) and the primary planetary gear carrier (13), between the plurality of secondary planetary gears (11) and the secondary planetary gear carrier (15) and between the plurality of tertiary planetary gears (19) and the tertiary planetary gear carrier (16).

4. The miniature high-reduction-ratio power device integrated within the outer rotor according to claim 1, wherein a third bearing (22) is disposed between the planetary reducer output shaft (21) and the end cover (20).

5. The miniature high-reduction-ratio power device integrated within the outer rotor according to claim 1, wherein an inner wall of the internal fixing casing (5) is provided with inner ring teeth (23), and the plurality of first planetary gears (10), the plurality of second planetary gears (11) and the plurality of tertiary planetary gears (19) are all meshed with the inner ring teeth (23).
